(19) United States
(12) Patent Application Publication
(10) Pub. No.: US 2013/0117491 A1
(43) Pub. Date: May 9, 2013

(54) ELECTRONIC DEVICE AND CONTROL METHOD THEREOF

(71) Applicant: Yong-sang HWANG, Suwon-si (KR)

(72) Inventor: Yong-sang HWANG, Suwon-si (KR)

(73) Assignee: Samsung Electronics Co., Ltd, Suwon-si (KR)

(21) Appl. No.: 13/596,342

(22) Filed: Aug. 28, 2012

(30) Foreign Application Priority Data
Nov. 9, 2011 (KR) 10-2011-0116349

(51) Int. Cl. G06F 13/00

(52) U.S. Cl. 710/316

(57) ABSTRACT

An electronic device and a control method thereof, the electronic device which provides input/output functions of an image signal, the electronic device including: an input signal processor which processes an input image signal input by an external image source; an output signal processor which outputs an output image signal to an external display apparatus; a connector which is connected to the external image source or the external display apparatus; a switching unit which switches on/off a path between the connector and the input signal processor or the output signal processor; and a controller which controls the switching operation of the switching unit based on an information signal input or output through the connector. With this configuration, an electronic device and a control method thereof enables input/output of an image signal to/from an external device through a single connector.

### CROSS-REFERENCE TO RELATED APPLICATIONS

This application claims priority from Korean Patent Application No. 10-2011-0116349, filed on Nov. 9, 2011 in the Korean Intellectual Property Office, the disclosure of which is incorporated herein by reference in its entirety.

### BACKGROUND OF THE INVENTION

1. Field of the Invention

Apparatuses and methods consistent with the exemplary embodiments relate to an electronic device and a control method thereof, and more particularly, to an electronic device and a control method thereof which provides input/output functions of an image signal.

2. Description of the Related Art

In the case of an electronic device which has a computer main body combined with a monitor such as an all-in-one computer, a computer main body including a graphic processing unit (GPU) for processing computer graphic and a monitor including a scaler to output an input image to a screen are combined into one device. Such an electronic device may be connected to an external device through a connector, and thus may be used as an image source device which transmits an image signal to an external display apparatus by connecting an external display apparatus such as a monitor or a TV, or may be used as a display apparatus for receiving and displaying an image signal by being connected to an external image source such as a computer main body, a set-top box or a DVD player.

FIGS. 1 and 2 illustrate a signal transmission path when a conventional electronic device 100 which includes input/output functions is connected to an external device 10.

FIG. 1 illustrates the case where the electronic device 100 is connected to an external display apparatus 11. The electronic device 100 is connected to the external display apparatus 11 through an output connector 140 connected to a GPU 120 to thereby transmit an image signal, which is processed by the GPU 120, to the external display apparatus 11.

FIG. 2 illustrates the case where the electronic device 100 is connected to an external image source 12. The electronic device 100 is connected to the external image source 12 through an input connector 150 connected to a scaler 130, to thereby receive and display on a display unit 110 an image signal received from the external image source 12.

As shown in FIGS. 1 and 2, in the conventional art, there are two paths: 1) a path for processing an image signal output by the GPU 120 and transmitting the image signal to the external display apparatus 11 through the output connector 140; and 2) a path for transmitting to the scaler 130 an image signal input from the input connector 150 connected to the external image source. That is, a user must select and connect a particular connector among a plurality of connectors between an electronic device 100 and an external device according to an intended use of the external device 10 to be connected.

If there is a plurality of connectors, the type of input/output connectors is the same, and a normal user may be confused as to which connector to use in order to connect the external device. If the external device is connected to the connector which is not consistent with its intended use, the desired operation may not be performed. Also, as a plurality of connectors should be mounted in the electronic device, design of a small-sized device or an electronic device with a sufficient amount of internal space may be difficult to accomplish.

### SUMMARY OF THE INVENTION

Accordingly, exemplary embodiments described herein provide an electronic device which provides input/output functions of an image signal and enables input/output of an image signal to/from an external device through a single connector.

Additional features and utilities of the present general inventive concept will be set forth in part in the description which follows and, in part, will be obvious from the description, or may be learned by practice of the general inventive concept.

The foregoing and/or other features and utilities may be achieved by providing an electronic device which provides input/output functions of an image signal, the electronic device including: an input signal processor which processes an input image signal input by an external image source; an output signal processor which outputs an output image signal to an external display apparatus; a connector which is connected to the external image source or the external display apparatus; a switching unit which switches on/off a path between the connector and the input signal processor or the output signal processor; and a controller which controls the switching operation of the switching unit based on an information signal input or output through the connector.

The controller may include a detector which detects the information signal, and a control signal output unit which outputs a switching control signal to the switching unit based on a detection result of the detector.

The information signal may include a hot plug detect (HPD) signal and an extended display identification data (EDID) signal, and the detector may detect the HPD signal and the EDID signal.

The detector may include a first detector which detects an HPD signal in a path between the output signal processor and the switching unit, a second detector which detects an HPD signal in a path between the switching unit and the connector, and a third detector which detects an EDID signal in a path between the switching unit and the connector.

The first, second and third detectors may have a predetermined logic state depending on a type of a device connected to the connector, and the control signal output unit may output a switching control signal corresponding to the logic state based on a preset table value.

The detector and the control signal output unit may be provided as a single integrated circuit (IC).

The information signal may be output by the input signal processor and transmitted to the external image source through the connector if the connector is connected to the external image source, and the information signal may be transmitted from the external display apparatus to the output signal processor through the connector if the connector is connected to the external display apparatus.

The input signal processor may include a scaler and the output signal processor may include a graphic processing unit (GPU).

The connector may include a plurality of pins, which includes at least one pin transmitting the input image signal and the output image signal, and at least one pin transmitting the information signal.

The connector may provide at least one interface among a high definition multimedia interface (HDMI), a digital visual interface (DVI) and a digital port (DP).

The foregoing and/or other aspects may be achieved by providing a control method of an electronic device which includes an output signal processor and an input signal processor, the control method including: connecting a connector to an external device; detecting an information signal which is input or output through the connector; outputting a switching control signal based on a detection result; and switching on/off a path between the connector and the output signal processor or the input signal processor based on the switching control signal.

The information signal may include a hot plug detect (HPD) signal and an extended display identification data (EDID) signal, and the detecting may include detecting the HPD signal and the EDID signal.

The detecting may include detecting an HPD signal in a path between the output signal processor and the switching circuit, detecting an HPD signal in a path between the switching circuit and the connector, and detecting an EDID signal in a path between the switching circuit and the connector.

The detecting may include determining a predetermined logic state, and the outputting the switching control signal may include outputting a switching control signal corresponding to the logic state based on a preset table value.

The information signal may be output by the input signal processor and transmitted to the external image source through the connector if the connected external device is an external image source, and the information signal may be transmitted from the external display apparatus to the output signal processor through the connector if the connected external device is an external display apparatus.

The input signal processor may include a scaler and the output signal processor may include a graphic processing unit (GPU).

The connector may include a plurality of pins, which includes at least one pin transmitting an image signal, and at least one pin transmitting the information signal.

The connector may provide at least one interface among a high definition multimedia interface (HDMI), a digital visual interface (DVI) and a digital port (DP).

The foregoing and/or other features and utilities may also be achieved by providing an electronic device to input image signals and output image signals from/to an external device, the electronic device comprising: a connector to connect to the external device and to receive input image signals when the external device is an external image source and to transmit output image signals when the external device is an external display apparatus; an input signal processor to process the input image signals; an output signal processor to output the output image signals; and a controller to control either the output signal processor or the input signal processor to communicate with the external device based on an information signal input or output through the connector.

In an exemplary embodiment, the controller comprises: a detector to detect the information signal; and a switching unit to switch a connection between the input signal processor or the output signal processor and the external device for the communication with the external device based on the detected information signal input or output through the connector.

In an exemplary embodiment, the information signal comprises a hot plug detect (HPD) signal and an extended display identification data (EDID) signal, and the detector detects the HPD signal and the EDID signal.

In an exemplary embodiment, the detector comprises: a first detector which detects an HPD signal in a path between the output signal processor and the switching unit; a second detector which detects an HPD signal in a path between the switching unit and the connector.

In an exemplary embodiment, the first, second and third detectors have a predetermined logic state depending on a type of a device connected to the connector, and the switching unit switches between the output signal processor and the input signal processor corresponding to the logic state based on preset table values.

In an exemplary embodiment, the connector comprises a plurality of pins, which comprises at least one pin transmitting both the input image signal and the output image signal, and at least one pin transmitting the information signal.

The foregoing and/or other features and utilities may also be achieved by providing a control method of an electronic device which comprises an output signal processor and an input signal processor, the control method comprising: connecting to an external device; detecting an information signal which is input or output through the connection; and switching the connection between the external device and the output signal processor or the input signal processor based on the detection result.

### BRIEF DESCRIPTION OF THE DRAWINGS

The above and/or other features and utilities of the present general inventive concept will become apparent and more readily appreciated from the following description of the exemplary embodiments, taken in conjunction with the accompanying drawings, in which:

FIG. 1 illustrates a signal transmission path when a conventional electronic device is connected to an external display apparatus;

FIG. 2 illustrates a signal transmission path when the conventional electronic device is connected to an external image source;

FIG. 3 is a control block diagram of an electronic device according to an exemplary embodiment of the present inventive concept;

FIGS. 4 and 5 illustrate a process of transmitting a hot plug detect (HPD) signal and an extended display identification data (EDID) signal;

FIGS. 6 to 9 illustrate a switching operation according to a detection result for an information signal; and

FIG. 10 is a control flowchart of the electronic device according to an exemplary embodiment of the present inventive concept.

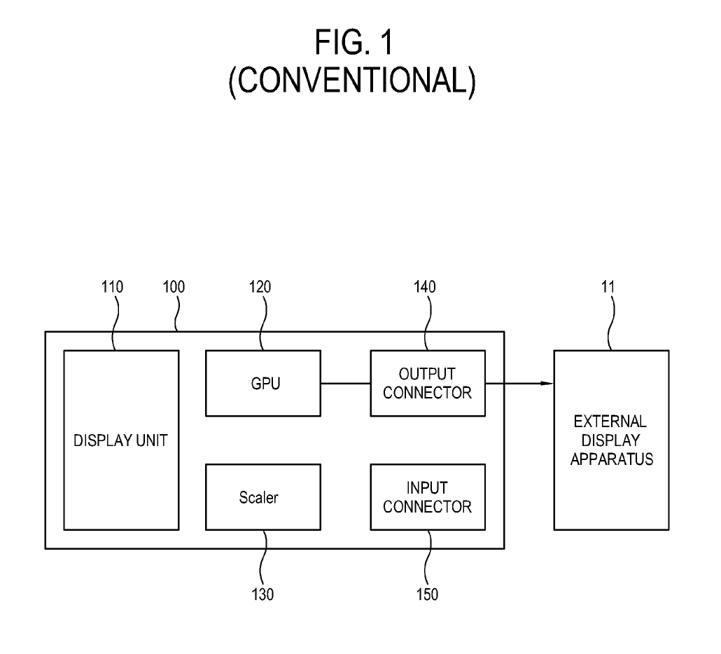

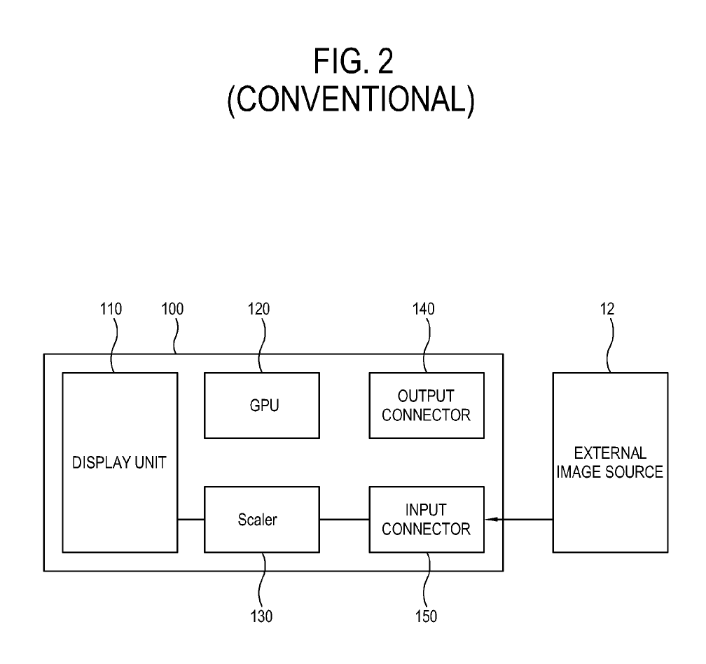

### DETAILED DESCRIPTION OF THE PREFERRED EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

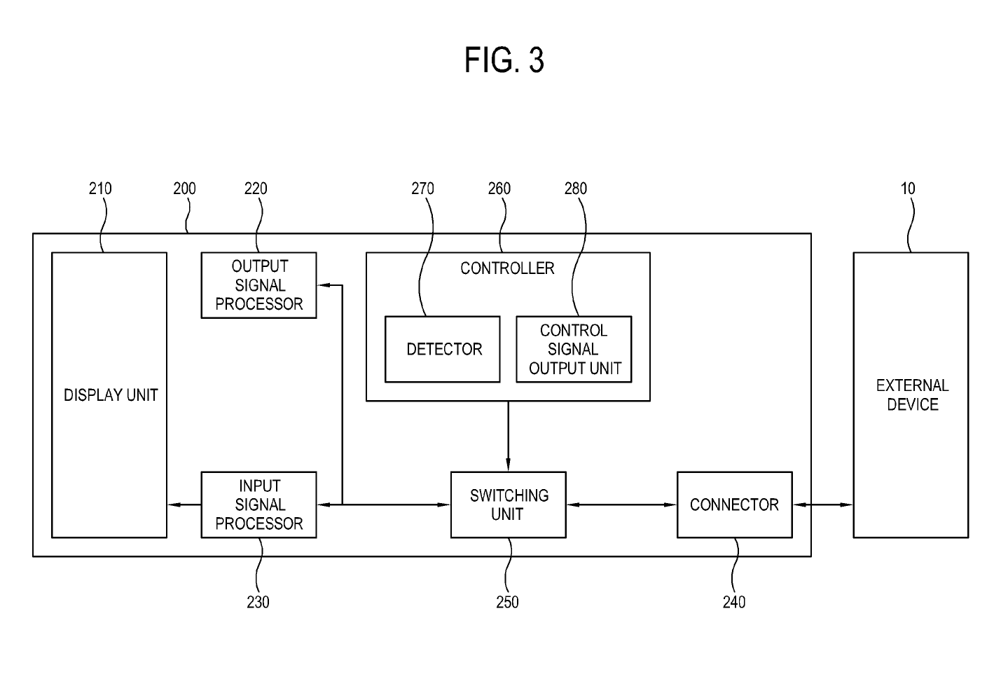

FIG. 3 is a control block diagram of an electronic device 200 according to an exemplary embodiment of the present inventive concept.

As shown in FIG. 3, the electronic device 200 according to the present embodiment may include an input signal processor 230, an output signal processor 220, a connector 240, a switching unit 250, and a controller 260. The electronic device 200 according to the present embodiment may process an image signal and display the processed image signal on the display unit 210, or receive an image signal from an external image source 12 and output the image signal through a display unit 210, or output the image signal to an external device 10. The electronic device 200 may include an all-in-one computer, a digital TV, a tablet PC, etc., but is not limited thereto.

The input signal processor 230 processes an input image signal that is input by the external device 10. If the external device 10 which is connected to the connector 240 (to be described later) is an image source (i.e., an external image source), the input signal processor 230 processes the input image signal that is input by the external device 10 and displays the processed input image signal on the display unit 210 of the electronic device 200. The input signal processor 230 may include a scaler.

The output signal processor 220 outputs an image signal to the external device 10. If the external device 10 which is connected to the connector 240 (to be described later) is a display apparatus (i.e., an external display apparatus), the output signal processor 220 outputs the generated output image signal to the external device 10 for display, i.e., the output signal processor 220 functions as a source device for the external device 10. The output signal processor 220 may include a graphic processing unit (GPU).

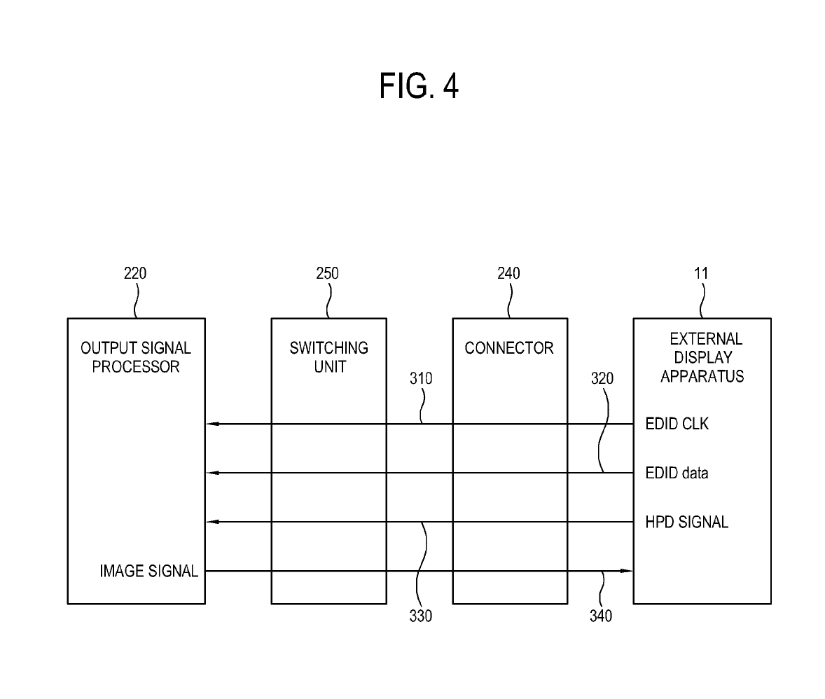

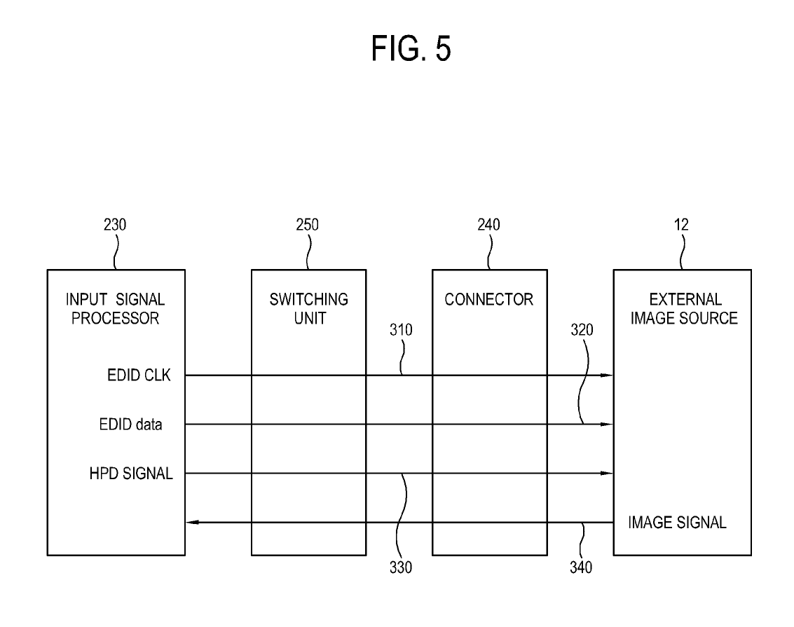

The connector 240 may be connected to the external device 10, which can be an external image source 12 (see FIG. 5, to be described later) or an external display apparatus 11 (see FIG. 4, to be described later). If the external device 10 is an external image source, it may include a computer main body, a set-top box or a DVD player which generates and processes image data for transmission to the electronic device 200. If the external device 10 is an external display apparatus, it may include a monitor or a TV which receives an image signal from the electronic device 200 and displays the image signal thereon.

The connector 240 may include at least one of a high definition multimedia interface (HDMI), a digital visual interface (DVI) and a digital port (DP). As HDMI, DVI and DP may perform interactive data transmission, the electronic device 200 may input/output various control signals including an image signal or an information signal (to be described later) with respect to an external device that is connected through the connector 240. The connector 240 may include other known interfaces which may perform interactive digital or analog data transmission. The connector 240 may include a plurality of pins, which includes at least one pin transmitting an image signal and at least one pin transmitting an information signal.

The switching unit 250 switches on/off a path between the connector 240 and the input signal processor 230 or the output signal processor 220. A first end of the switching unit 250 is connected to the connector 240 and a second end thereof is connected to the input signal processor 230 or the output signal processor 220. The switching unit 250 selectively connects the connector 240 and one of the input signal processor 230 and the output signal processor 220 according to a control of the controller 260 (to be described later). The switching unit 250 may include an electronic circuit such as a switch integrated circuit (IC).

The controller 260 controls a switching operation of the switching unit 250 based on an information signal that is input or output through the connector 240. The controller 260 may include a control circuit including a switching element or gate element or a controller such as a micro computer.

The information signal is transmitted from a device acting as a display apparatus to a device acting as a source. The information signal may include a hot plug detect (HPD) signal and an extended display identification data (EDID) signal including information on the display apparatus.

The HPD signal is used for the source device to recognize connection of the display apparatus. The DVI performs a signal exchange through a no. 16 pin and the HDMI performs a signal transmission through a no. 25 pin. Through this communication, the source device recognizes that the display apparatus is connected thereto, and initiates EDID communication and outputs an image signal. Generally, the HPD signal is connected to a power signal through a pull up resistor in the display apparatus, and is recognized as a high voltage level in the case of 2.0V to 5.3V and recognized as a low voltage level in the case of 0V to 0.8V. The HPD signal line determines that the display apparatus is not connected to the source device in the case of the low voltage level, and upon change into the high voltage level, determines that the source device is connected to the display apparatus.

The EDID signal includes various types of information relating to the display apparatus. The EDID signal includes an EDID clock and EDID data. The EDID may include, e.g., information on a manufacturer name, a product type, an EDID version, a type of fluorescent substance or filter, timing, monitor size, brightness and pixels. The EDID signal is output by the display apparatus and transmitted only when the display apparatus is connected to the source device, and this may be detected by the signal transmission line.

The HPD signal and the EDID signal are inherent values of the display apparatus. If flow and data of such signals are identified, whether the connected device is a display apparatus or a source device may be determined. In the present embodiment, a process of transmitting the HPD signal and the EDID signal will be described later with reference to FIGS. 4 and 5.

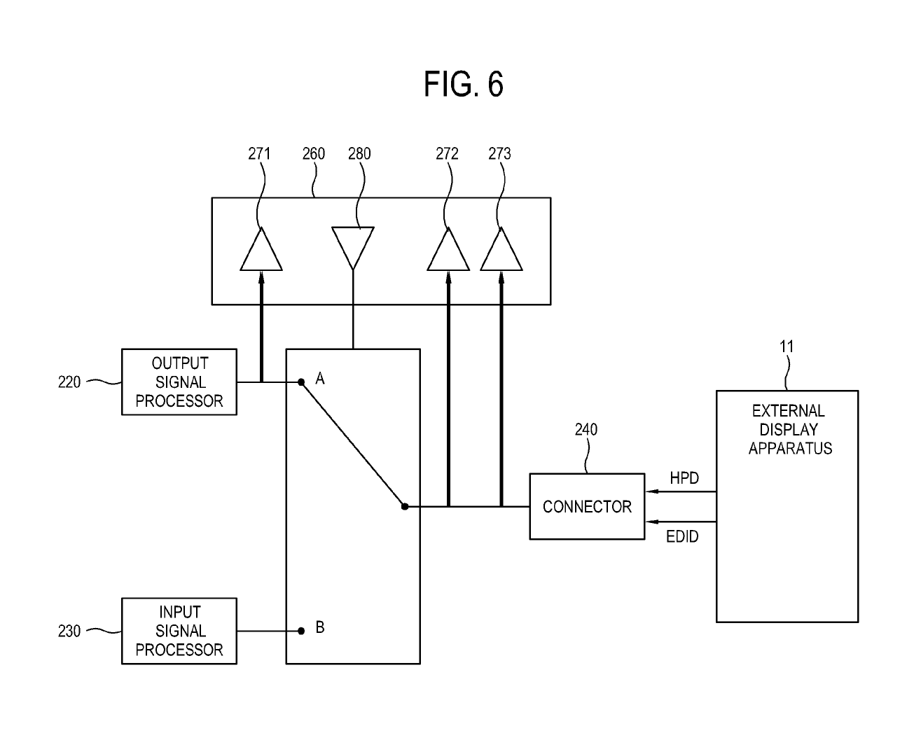

The controller 260 may include a detector 270 to detect an information signal, and a control signal output unit 280 to output a switching control signal to the switching unit 250 based on a detection result of the detector 270. The detector 270 may detect an HPD signal or an EDID signal in a path between the output signal processor 220 or the input signal processor 230, the switching unit 250 and the connector 240, and may have a predetermined logic state (high or low, or 1 or 0) according to a detection result. The control signal output unit 280 may output a switching control signal corresponding to each of predetermined logic states based on preset table values. The preset table values include information on whether to output a switching control signal corresponding to each of logic states according to the detection result of the detector 270. As shown in FIGS. 6 to 9, the detector 270 and the control signal output unit 280 may be integrally provided as a single IC or provided as ICs separately. The logic state of the detector 270 and the output of the switching control signal corresponding to the logic state will be described later with reference to FIGS. 6 to 9.

FIGS. 4 and 5 illustrate a process of transmitting the HPD signal and the EDID signal.

If an external device which is connected to the connector 240 of the electronic device 200 is the external display apparatus 11 (FIG. 4), the electronic device 200 according to an exemplary embodiment functions as a source device. Referring to FIG. 4, an output image signal 340 which is output by the output signal processor 220 is transmitted to the external display apparatus 11 through the switching unit 250 and the connector 240 (340), and the connected external display apparatus 11 transmits an EDID clock 310, EDID data 320 and an HPD signal 330 to the electronic device 200.

In contrast, if an external device which is connected to the connector 240 of the electronic device 200 is the external image source 12 (FIG. 5), the electronic device 200 according to the present embodiment functions as a display apparatus which receives and displays image data. Referring to FIG. 5, an input image signal 340 which is input by the connected external image source 12 is received through the connector 240, and the input signal processor 230 transmits the EDID clock 310, the EDID data 320 and the HPD signal 330 to the connected external image source 12.

FIGS. 6 to 9 illustrate switching operations of the switching unit 250 according to detection results of the detector 270 (illustrated as detectors 271-273 in controller 260).

As shown therein, the detector 270 (in the controller 260) may include a first detector 271 which detects an HPD signal in a path between the output signal processor 220 and the switching unit 250, a second detector 272 which detects an HPD signal in a path between the switching unit 250 and the connector 240, and a third detector 273 which detects an EDID signal in a path between the switching unit 250 and the connector 240. The first to third detectors 271 to 273 may have a predetermined logic state according to detection/non-detection of signals in each path, and the control signal output unit 280 may output a switching control signal to the switching unit 250 corresponding to the logic state.

In FIG. 6, the connector 240 is connected to the external display apparatus 11, and the switching unit 250 is connected to a path A to the output signal processor 220. If the external display apparatus 11 is connected to the connector 240, the HPD signal is transmitted to the electronic device 200 through the connector 240 and the first and second detectors 271 and 272 detect the HPD signal. The output signal processor 220 which performs a function as the source device may receive the EDID signal, and the third detector 273 detects the EDID signal transmitted from the external display apparatus 11 to the output signal processor 220. In this case, the logic state of the first to third detectors 271 to 273 fall under (1,1,1), and the control signal output unit 280 is not required to output the switching control signal since the switching path is desirable in the present state.

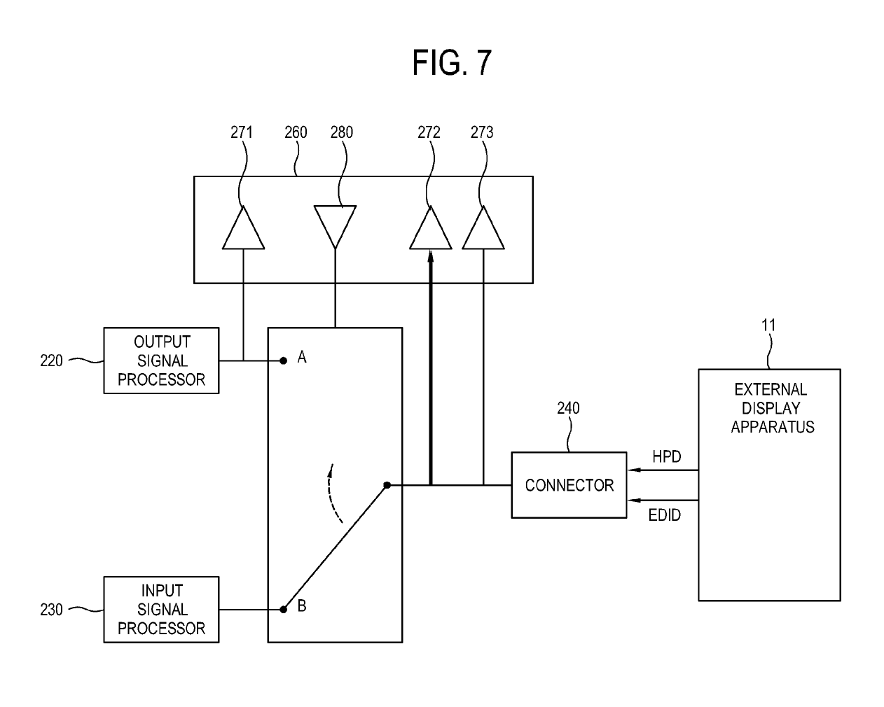

In FIG. 7, the connector 240 is connected to the external display apparatus 11, and the switching unit 250 is connected to a path B to the input signal processor 230. If the external display apparatus 11 is connected to the connector 240, the HPD signal is transmitted to the electronic device 200 through the connector 240 and the second detector 272 detects the HPD signal. The input signal processor 230 does not perform a function as the source device does not receive the EDID signal. Accordingly, the logic state of the first to third detectors 271 to 273 fall under (0,1,0), and the control signal output unit 280 outputs a switching control signal to the switching unit 250 and the switching unit 250 switches from the path B to A since the present switching path is not desirable.

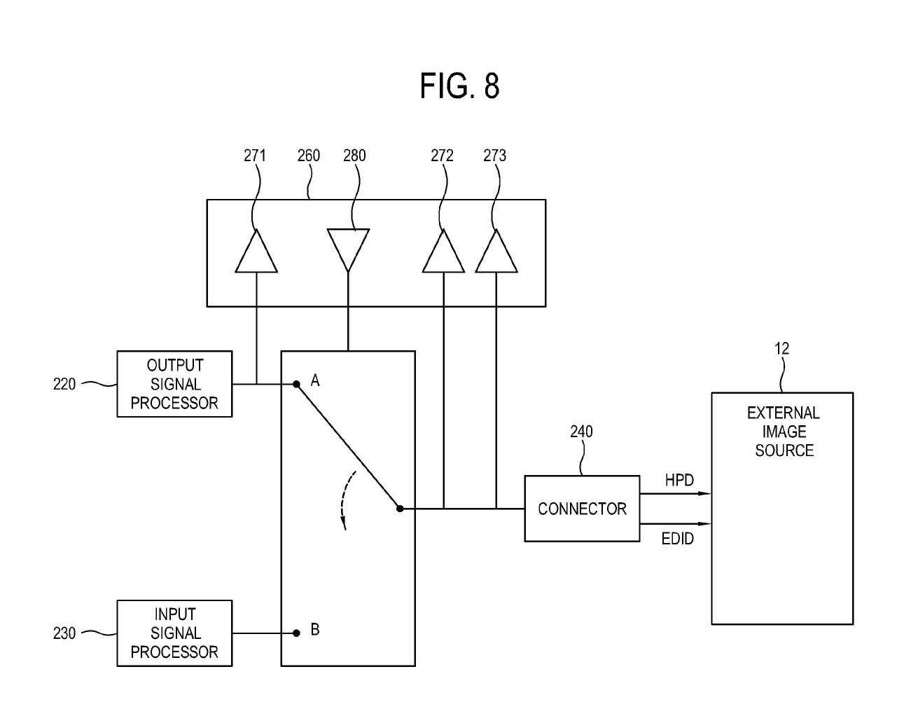

In FIG. 8, the connector 240 is connected to the external image source 12, and the switching unit 250 is connected to the path A to the output signal processor 220. In this case, since neither the output signal processor 220 nor the external image source 12 performs a function as the display apparatus, neither the HPD signal nor the EDID signal is transmitted. Accordingly, the logic state of the first to third detectors 271 to 273 fall under (0,0,0), and the control signal output unit 280 outputs the switching control signal to the switching unit 250 and the switching unit 250 switches from the path A to B since the present switching path is not desirable.

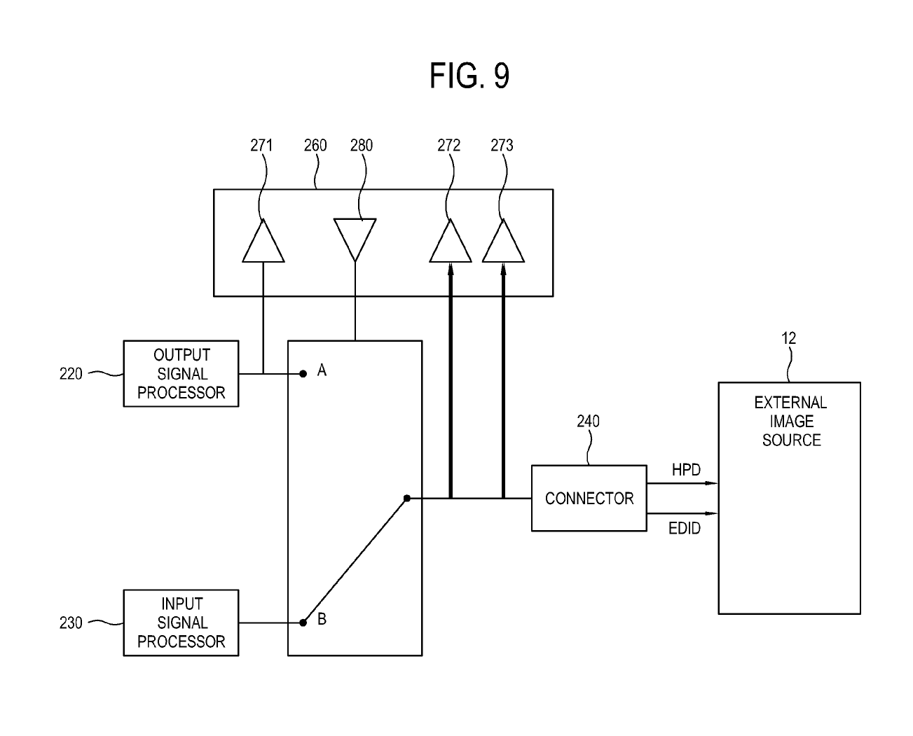

In FIG. 9, the connector 240 is connected to the external image source 12, and the switching unit 250 is connected to the path B to the output signal processor 220. If the external image source 12 is connected to the connector 240, the HPD signal is transmitted to the external image source 12 from the input signal processor 230 performing a function as the display apparatus through the connector 240, and the second detector 272 detects the HPD signal. The third detector 273 detects the EDID signal transmitted by the output signal processor 220. In this case, the logic state of the first to third detectors 271 to 273 fall under (0,1,1), and the control signal output unit 280 is not required to output a switching control signal to the switching unit 250 since the switching path is desirable.

The type of the device connected to the connector 240 and the output/non-output of the switching control signal according to the switching location in FIGS. 6 to 9 are shown in the table below.

| Connected | Current | Logic state | |
|---|---|---|---|
| external device | switching state | of detector | Switching |
| Display apparatus | A | (1, 1, 1) | Not switched |
| Display apparatus | B | (0, 1, 0) | Switched |
| | | | from B to A |
| Image source | A | (0, 0, 0) | Switched |
| | | | from A to B |
| Image source | B | (0, 1, 1) | Not switched |

The electronic device 200 according to the present embodiment may store the table values, and the control signal output unit 280 may output a switching control signal corresponding to the logic state of the detector 270 based on the table values.

As a result, the electronic apparatus 200 inputs and outputs an image signal through a single connector by detecting an HPD signal or an EDID signal and performing a switching operation depending on the type of connected external devices.

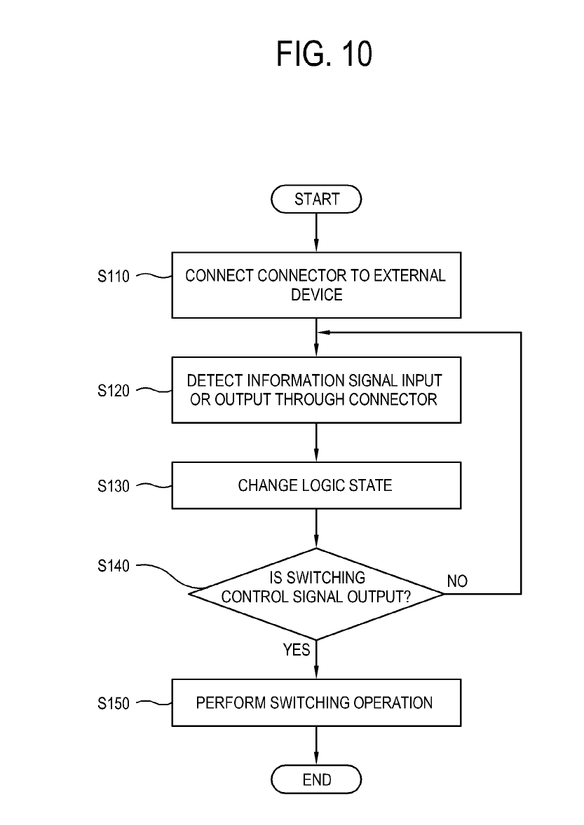

FIG. 10 is a control flowchart of the electronic device 200 according to an exemplary embodiment.

The electronic device 200 includes the output signal processor 220 and the input signal processor 230. The output signal processor 220 may include a GPU and the input signal processor 230 may include a scaler. The electronic device 200 includes a connector to be connected to an external device, and a switching circuit to switch on/off a path between the connector 240 and the output signal processor 220 or the input signal processor 230.

The connector 240 of the electronic device 200 is connected to an external device such as the external display apparatus 11 or the external image source 12 (S110). If the external device is connected to the connector 240, an information signal is input or output through the connector. The information signal may include a HPD signal and an EDID signal, which are transmitted to a device acting as a source from a device acting as a display apparatus. That is, if the external display apparatus 11 is connected, the electronic device 200 receives the information signal from the external display apparatus 11 since the electronic device 200 acts as the source. If the external image source 12 is connected, the electronic device 200 may transmit the information signal to the external image source 12 since the electronic device 200 acts as the display apparatus.

The electronic device 200 detects an input or output information signal (S120). The electronic device 200 may detect the HPD signal in the path between the output signal processor 220 and the switching circuit, may detect the HPD signal in the path between the switching circuit and the connector 240, and may detect the EDID signal in the path between the switching circuit and the connector 240.

The predetermined logic state is determined according to the detection results of the information signal (S130). The switching control signal is output according to the logic state (S140). The electronic device 200 may store in a table the output/non-output of the switching control signal according to the logic state, and output the switching control signal based on the table values. If the switching control signal is output, the switching circuit switches the path between the connector and the output signal processor 220 or input signal processor 230 according to the switching control signal (S150).

If the external display apparatus 11 is connected to the connector according to the switching operation of the switching circuit, the path is connected between the output signal processor 220 and the connector 240. If the external image source 12 is connected to the connector 240, the path is connected between the input signal processor 230 and the connector 240. Accordingly, the electronic device 200 which inputs and outputs the image signal through a single connector is provided.

As described above, an electronic device and a control method thereof according to the present invention inputs and outputs an image signal through a single connector.

Although a few exemplary embodiments of the present general inventive concept have been shown and described, it will be appreciated by those skilled in the art that changes may be made in these exemplary embodiments without departing from the principles and spirit of the general inventive concept, the range of which is defined in the appended claims and their equivalents.

What is claimed is:

1. An electronic device which provides input/output functions of an image signal, the electronic device comprising:
an input signal processor which processes an input image signal input by an external image source;
an output signal processor which outputs an output image signal to an external display apparatus;
a connector which is connected to the external image source or the external display apparatus;
a switching unit which switches on/off a path between the connector and the input signal processor or the output signal processor; and
a controller which controls the switching operation of the switching unit based on an information signal input or output through the connector.

2. The electronic device according to claim 1, wherein the controller comprises a detector which detects the information signal, and a control signal output unit which outputs a switching control signal to the switching unit based on a detection result of the detector.

3. The electronic device according to claim 2, wherein the information signal comprises a hot plug detect (HPD) signal and an extended display identification data (EDID) signal, and the detector detects the HPD signal and the EDID signal.

4. The electronic device according to claim 3, wherein the detector comprises a first detector which detects an HPD signal in a path between the output signal processor and the switching unit, a second detector which detects an HPD signal in a path between the switching unit and the connector, and a third detector which detects an EDID signal in a path between the switching unit and the connector.

5. The electronic device according to claim 4, wherein the first, second and third detectors have a predetermined logic state depending on a type of a device connected to the connector, and the control signal output unit outputs a switching control signal corresponding to the logic state based on a preset table value.

6. The electronic device according to claim 2, wherein the detector and the control signal output unit are provided as a single integrated circuit (IC).

7. The electronic device according to claim 1, wherein the information signal is output by the input signal processor and transmitted to the external image source through the connector if the connector is connected to the external image source, and the information signal is transmitted from the external display apparatus to the output signal processor through the connector if the connector is connected to the external display apparatus.

8. The electronic device according to claim 1, wherein the input signal processor comprises a scaler and the output signal processor comprises a graphic processing unit (GPU).

9. The electronic device according to claim 1, wherein the connector comprises a plurality of pins, which comprises at least one pin transmitting the input image signal and the output image signal, and at least one pin transmitting the information signal.

10. The electronic device according to claim 1, wherein the connector provides at least one interface among a high definition multimedia interface (HDMI), a digital visual interface (DVI) and a digital port (DP).

11. A control method of an electronic device which comprises an output signal processor and an input signal processor, the control method comprising:
connecting a connector to an external device;
detecting an information signal which is input or output through the connector;
outputting a switching control signal based on a detection result; and
switching on/off a path between the connector and the output signal processor or the input signal processor based on the switching control signal.

12. The control method according to claim 11, wherein the information signal comprises a hot plug detect (HPD) signal and an extended display identification data (EDID) signal, and the detecting comprises detecting the HPD signal and the EDID signal.

13. The control method according to claim 12, wherein the detecting comprises detecting an HPD signal in a path between the output signal processor and the switching circuit, detecting an HPD signal in a path between the switching circuit and the connector, and detecting an EDID signal in a path between the switching circuit and the connector.

14. The control method according to claim 13, wherein the detecting comprises determining a predetermined logic state, and the outputting the switching control signal comprises outputting a switching control signal corresponding to the logic state based on a preset table value.

15. The control method according to claim 11, wherein the information signal is output by the input signal processor and transmitted to the external image source through the connector if the connected external device is an external image source, and the information signal is transmitted from the external display apparatus to the output signal processor through the connector if the connected external device is an external display apparatus.

16. The control method according to claim 11, wherein the input signal processor comprises a scaler and the output signal processor comprises a graphic processing unit (GPU).

17. The control method according to claim 11, wherein the connector comprises a plurality of pins, which comprises at least one pin transmitting an image signal, and at least one pin transmitting the information signal.

18. The control method according to claim 11, wherein the connector provides at least one interface among a high definition multimedia interface (HDMI), a digital visual interface (DVI) and a digital port (DP).

19. An electronic device to input image signals and output image signals from/to an external device, the electronic device comprising:
a connector to connect to the external device and to receive input image signals when the external device is an external image source and to transmit output image signals when the external device is an external display apparatus;
an input signal processor to process the input image signals;
an output signal processor to output the output image signals; and
a controller to control either the output signal processor or the input signal processor to communicate with the external device based on an information signal input or output through the connector.

20. The electronic device of claim 19, wherein the controller comprises:
a detector to detect the information signal; and
a switching unit to switch a connection between the input signal processor or the output signal processor and the external device for the communication with the external device based on the detected information signal input or output through the connector.

21. The electronic device according to claim 20, wherein the information signal comprises a hot plug detect (HPD) signal and an extended display identification data (EDID) signal, and the detector detects the HPD signal and the EDID signal.

22. The electronic device according to claim 21, wherein the detector comprises:
a first detector which detects an HPD signal in a path between the output signal processor and the switching unit;
a second detector which detects an HPD signal in a path between the switching unit and the connector; and
a third detector which detects an EDID signal in a path between the switching unit and the connector.

23. The electronic device according to claim 22, wherein the first, second and third detectors have a predetermined logic state depending on a type of a device connected to the connector, and the switching unit switches between the output signal processor and the input signal processor corresponding to the logic state based on preset table values.

24. The electronic device according to claim 19, wherein the connector comprises a plurality of pins, which comprises at least one pin transmitting both the input image signal and the output image signal, and at least one pin transmitting the information signal.

25. A control method of an electronic device which comprises an output signal processor and an input signal processor, the control method comprising:
connecting to an external device;
detecting an information signal which is input or output through the connection; and
switching the connection between the external device and the output signal processor or the input signal processor based on the detection result.
